(19) United States
(12) Patent Application Publication
(10) Pub. No.: US 2016/0186574 A1
(43) Pub. Date: Jun. 30, 2016

(54) INTERIOR COOLING CHANNELS IN TURBINE BLADES

(71) Applicant: General Electric Company, Schenectady, NY (US)

(72) Inventors: Joseph Anthony Weber, Simpsonville, SC (US); Michael James Healy, Greenville, SC (US)

(73) Assignee: General Electric Company

(21) Appl. No.: 14/583,865

(22) Filed: Dec. 29, 2014

(51) Int. Cl. F01D 5/18; F01D 5/14

(52) U.S. Cl. CPC F01D 5/186; F01D 5/141; F05D 2220/32; F05D 2230/11; F05D 2230/21; F05D 2240/30; F05D 2260/202; F05D 2250/712

(57) ABSTRACT

A blade for a turbine of a gas turbine engine that includes an airfoil, the airfoil having a leading edge, a trailing edge, an outboard tip, and an inboard end. The airfoil may further include a cooling configuration that includes a plurality of cooling channels for receiving and directing a coolant. The cooling channels may include a linear cooling channel and a curved cooling channel. The blade may also include a contoured shape defined by the airfoil between the inboard end and the outboard tip, with the contoured shape being configured so to include a target area inaccessible to a linear reference line extending radially from a position at the inboard end of the airfoil. The curved cooling channels may be configured to extend between an upstream end and a downstream end so to intersect the target area therebetween.

### BACKGROUND OF THE INVENTION

This present application relates to interior cooling channels of turbine blades in gas turbine engines. More specifically, but not by way of limitation, the present application relates to non-linear interior cooling channels formed within long rotor blades within the aft rows of turbine rotor blades.

It will be appreciated that gas turbine engines generally include a compressor, combustor, and turbine. The compressor and turbine sections generally include rows of blades that are axially stacked in stages. Each stage includes a row of circumferentially-spaced stator blades, which are fixed, and a row of rotor blades, which rotate about a central turbine axis or shaft. In operation, generally, the compressor rotor blades rotate about the shaft, and, acting in concert with the stator blades, compress a flow of air. The supply of compressed air then is used in the combustor to combust a supply of fuel. The resulting flow of hot expanding gases from the combustion, i.e., the working fluid, is expanded through the turbine section of the engine. The flow of working fluid through the turbine induces the rotor blades to rotate. The rotor blades are connected to a central shaft such that the rotation of the rotor blades rotates the shaft.

In this manner, the energy contained in the fuel is converted into the mechanical energy of the rotating shaft, which, for example, may be used to rotate the rotor blades of the compressor, such that the supply of compressed air needed for combustion is produced, and the coils of a generator, such that electrical power is generated. During operation, because of the extreme temperatures of the hot-gas path, the velocity of the working fluid, and the rotational velocity of the engine, turbine blades, which, as described, generally include both the rotating rotor blades and the fixed, circumferentially-spaced stator blades, become highly stressed with extreme mechanical and thermal loads.

The ever-increasing demand for energy makes the engineering of more efficient gas turbine engines an ongoing and significant objective. While several strategies for increasing the efficiency of turbine engines are known, it remains a challenging objective because these alternatives, which, for example, include increasing the size of the engine, increasing the temperatures through the hot-gas path, and increasing the rotational velocities of the rotor blades, generally place additional strain on parts that are already highly stressed, for example, turbine rotor and stator blades. As a result, improved apparatus, methods and/or systems that reduce operational stresses placed on turbine blades or allow the turbine blades to better withstand these stresses are in great demand. As one of ordinary skill in the art will appreciate, one strategy for alleviating the thermal stress on the blades is through cooling them during operation. Effective cooling, for example, may allow the blades to withstand higher firing temperatures, withstand greater mechanical stresses at high operating temperatures, and/or extend the part-life of the blades, all of which may allow the turbine engine to be more cost-effective and efficient in its operation. One way to cool blades during operation is through the use of internal cooling passageways or circuits. Generally, this involves passing a relatively cool supply of compressed air, which may be supplied by the compressor of the turbine engine, through internal cooling channels within the blades. As the compressed air passes through the blade, it convectively cools the blade, which allows the part to withstand firing temperatures that it otherwise could not.

For a number of reasons, it will be appreciated that great care is required in designing and manufacturing the configuration of these cooling channels. First, the use of cooling air comes at a price. That is, air that is diverted from the compressor to the turbine section of the engine for cooling bypasses the combustor and, thus, decreases the efficiency of the engine. As such, cooling passages must be designed to use air in a highly effective manner, i.e., provide the necessary coverage and cooling efficiency, so that a minimum amount of air is needed for this purpose. Second, newer, more aggressively shaped aerodynamic blade configurations are thinner and more curved or twisted, which often rules out the usage of linear cooling channels that stretch the length of the turbine blade, while the thinness of the blades requires the cooling passages to perform well while having a compact design. Third, to reduce mechanical loads, cooling passages may be formed to remove unnecessary weight from the blade; however, the blades still must remain strong to withstand the extreme mechanical loads. Cooling channels, therefore, must be designed such that the turbine blade has a lightweight but strong construction, while stress concentrations that would negatively affect the blades resilience are avoided. As such, turbine blade cooling configurations that perform well in more aggressively shaped, thinner aerodynamic blade configurations, promote lighter blade internal construction, maintain the structural support of the component, while also delivering high cooling effectiveness would be in commercial demand.

### BRIEF DESCRIPTION OF THE INVENTION

The present application thus describes a blade for a turbine of a gas turbine engine that includes an airfoil, the airfoil having a leading edge, a trailing edge, an outboard tip, and an inboard end where the airfoil attaches to a root configured to couple the turbine blade to a rotor disc. The airfoil may further include a cooling configuration that includes a plurality of elongated cooling channels for receiving and directing a coolant through the airfoil. The plurality of cooling channels may include at least a linear cooling channel and a curved cooling channel. The blade may also include a contoured shape defined by the airfoil between the inboard end and the outboard tip, the contoured shape configured so to include a target area inaccessible to a linear reference line extending radially from a position at the inboard end of the airfoil. The curved cooling channels may be configured to extend between an upstream end and a downstream end so to intersect the target area therebetween.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a schematic representation of an exemplary turbine engine in which blades according to embodiments of the present application may be used;

FIG. 2 is a sectional view of the compressor section of the combustion turbine engine of FIG. 1;

FIG. 3 is a sectional view of the turbine section of the combustion turbine engine of FIG. 1;

FIG. 4 is a side view of an exemplary turbine rotor blade in which embodiments of the present invention may be used;

FIG. 5 is a section view along sight line 5-5 of FIG. 4;

FIG. 6 is a section view along sight line 6-6 of FIG. 4;

FIG. 7 is a section view along sight line 7-7 of FIG. 4;

FIG. 8 is a section view along sight line 8-8 of FIG. 4;

FIG. 9 is a perspective view of an exemplary turbine rotor blade that includes a twisted, curved and tapered configuration in which embodiments of the present invention may be used;

FIG. 10 is a part section, part perspective view along sight line 10-10 of FIG. 9;

FIG. 11 is a side view of a turbine rotor blade depicting conventional linear cooling channels;

FIG. 12 is a perspective view of the turbine rotor blade of FIG. 11;

FIG. 13 is a side view of a turbine rotor blade depicting curved cooling channels according to an exemplary embodiment of the present invention;

FIG. 14 is a perspective view of the turbine rotor blade of FIG. 13;

FIG. 15 is a perspective view of a turbine rotor blade having a curved cooling channels according to an alternative embodiment of the present inventions;

FIG. 16 is a perspective view of a turbine rotor blade having a curved cooling channels according to an alternative embodiment of the present inventions; and

FIG. 17 is a perspective view of a turbine rotor blade having a curved cooling channels according to an alternative embodiment of the present inventions.

### DETAILED DESCRIPTION OF THE INVENTION

Aspects and advantages of the invention are set forth below in the following description, or may be obvious from the description, or may be learned through practice of the invention. Reference will now be made in detail to present embodiments of the invention, one or more examples of which are illustrated in the accompanying drawings. The detailed description uses numerical designations to refer to features in the drawings. Like or similar designations in the drawings and description may be used to refer to like or similar parts of embodiments of the invention. As will be appreciated, each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. It is to be understood that the ranges and limits mentioned herein include all sub-ranges located within the prescribed limits, inclusive of the limits themselves unless otherwise stated. Additionally, certain terms have been selected to describe the present invention and its component subsystems and parts. To the extent possible, these terms have been chosen based on the terminology common to the technology field. Still, it will be appreciate that such terms often are subject to differing interpretations. For example, what may be referred to herein as a single component, may be referenced elsewhere as consisting of multiple components, or, what may be referenced herein as including multiple components, may be referred to elsewhere as being a single component. In understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the precise usage of the terminology in the appended claims. Further, while the following examples are presented in relation to a certain type of turbine engine, the technology of the present invention also may be applicable to other types of turbine engines as would the understood by a person of ordinary skill in the relevant technological arts.

Given the nature of turbine engine operation, several descriptive terms may be used throughout this application so to explain the functioning of the engine and/or the several sub-systems or components included therewithin, and it may prove beneficial to define these terms at the onset of this section. Accordingly, these terms and their definitions, unless stated otherwise, are as follows. The terms “forward” and “aft”, without further specificity, refer to directions relative to the orientation of the gas turbine. That is, “forward” refers to the forward or compressor end of the engine, and “aft” refers to the aft or turbine end of the engine. It will be appreciated that each of these terms may be used to indicate movement or relative position within the engine. The terms “downstream” and “upstream” are used to indicate position within a specified conduit relative to the general direction of flow moving through it. (It will be appreciated that these terms reference a direction relative to an expected flow during normal operation, which should be plainly apparent to anyone of ordinary skill in the art.) The term “downstream” refers to the direction in which the fluid is flowing through the specified conduit, while “upstream” refers to the direction opposite that. Thus, for example, the primary flow of working fluid through a turbine engine, which begins as air moving through the compressor and then becomes combustion gases within the combustor and beyond, may be described as beginning at an upstream location toward an upstream or forward end of the compressor and terminating at an downstream location toward a downstream or aft end of the turbine. In regard to describing the direction of flow within a common type of combustor, as discussed in more detail below, it will be appreciated that compressor discharge air typically enters the combustor through impingement ports that are concentrated toward the aft end of the combustor (relative to the combustors longitudinal axis and the aforementioned compressor/turbine positioning defining forward/aft distinctions). Once in the combustor, the compressed air is guided by a flow annulus formed about an interior chamber toward the forward end of the combustor, where the air flow enters the interior chamber and, reversing it direction of flow, travels toward the aft end of the combustor. In yet another context, coolant flows through cooling passages may be treated in the same manner.

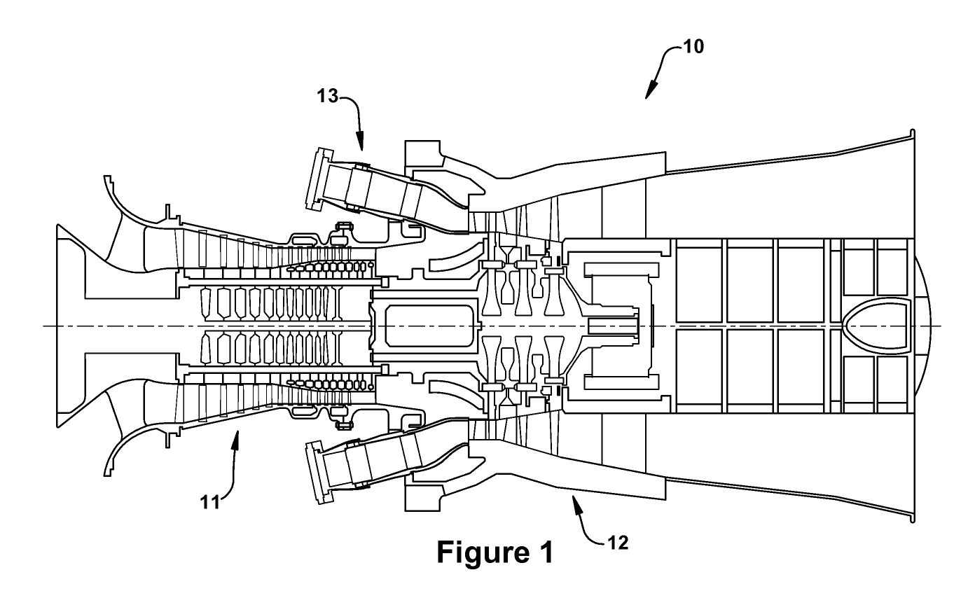

Additionally, given the configuration of compressor and turbine about a central common axis, as well as the cylindrical configuration common to many combustor types, terms describing position relative to an axis may be used herein. In this regard, it will be appreciated that the term “radial” refers to movement or position perpendicular to an axis. Related to this, it may be required to describe relative distance from the central axis. In this case, for example, if a first component resides closer to the central axis than a second component, the first component will be described as being either “radially inward” or “inboard” of the second component. If, on the other hand, the first component resides further from the central axis than the second component, the first component will be described herein as being either “radially outward” or “outboard” of the second component. Additionally, as will be appreciated, the term “axial” refers to movement or position parallel to an axis. Finally, the term “circumferential” refers to movement or position around an axis. As mentioned, while these terms may be applied in relation to the common central axis that extends through the compressor and turbine sections of the engine, these terms also may be used in relation to other components or sub-systems of the engine. By way of background, referring now to the figures, FIGS. 1 through 3 illustrate an exemplary combustion turbine engine in which embodiments of the present application may be used. It will be understood by those skilled in the art that the present invention is not limited to this type of usage. As stated, the present invention may be used in combustion turbine engines, such as the engines used in power generation and airplanes, steam turbine engines, and other types of rotary engines. The examples provided are not meant to be limiting to the type of the turbine engine.

FIG. 1 is a schematic representation of a combustion turbine engine 10. In general, combustion turbine engines operate by extracting energy from a pressurized flow of hot gas produced by the combustion of a fuel in a stream of compressed air. As illustrated in FIG. 1, combustion turbine engine 10 may be configured with an axial compressor 11 that is mechanically coupled by a common shaft or rotor to a downstream turbine section or turbine 12, and a combustor 13 positioned between the compressor 11 and the turbine 12.

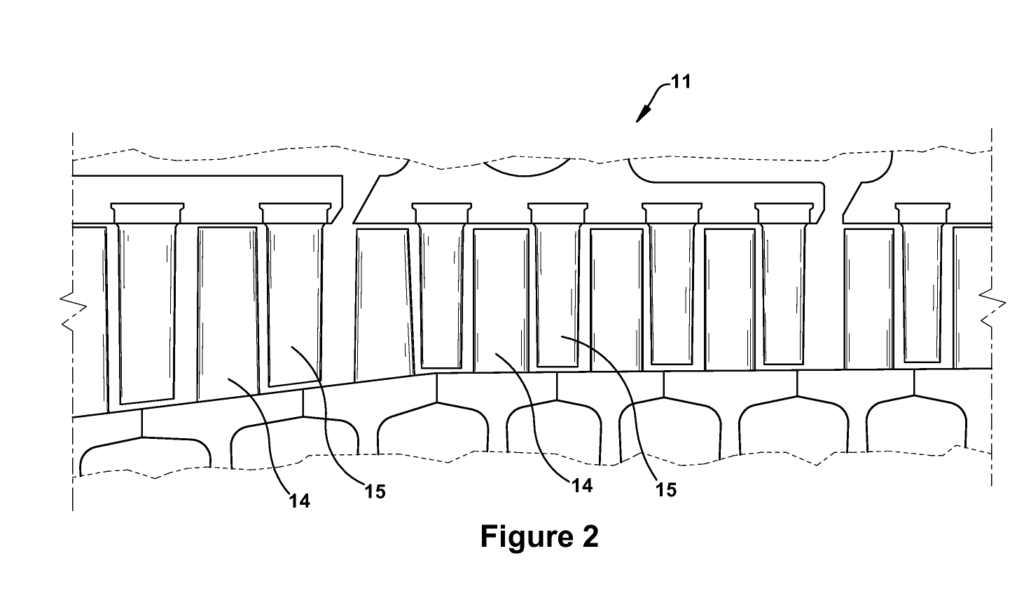

FIG. 2 illustrates a view of an exemplary multi-staged axial compressor 11 that may be used in the combustion turbine engine of FIG. 1. As shown, the compressor 11 may include a plurality of stages. Each stage may include a row of compressor rotor blades 14 followed by a row of compressor stator blades 15. Thus, a first stage may include a row of compressor rotor blades 14, which rotate about a central shaft, followed by a row of compressor stator blades 15, which remain stationary during operation.

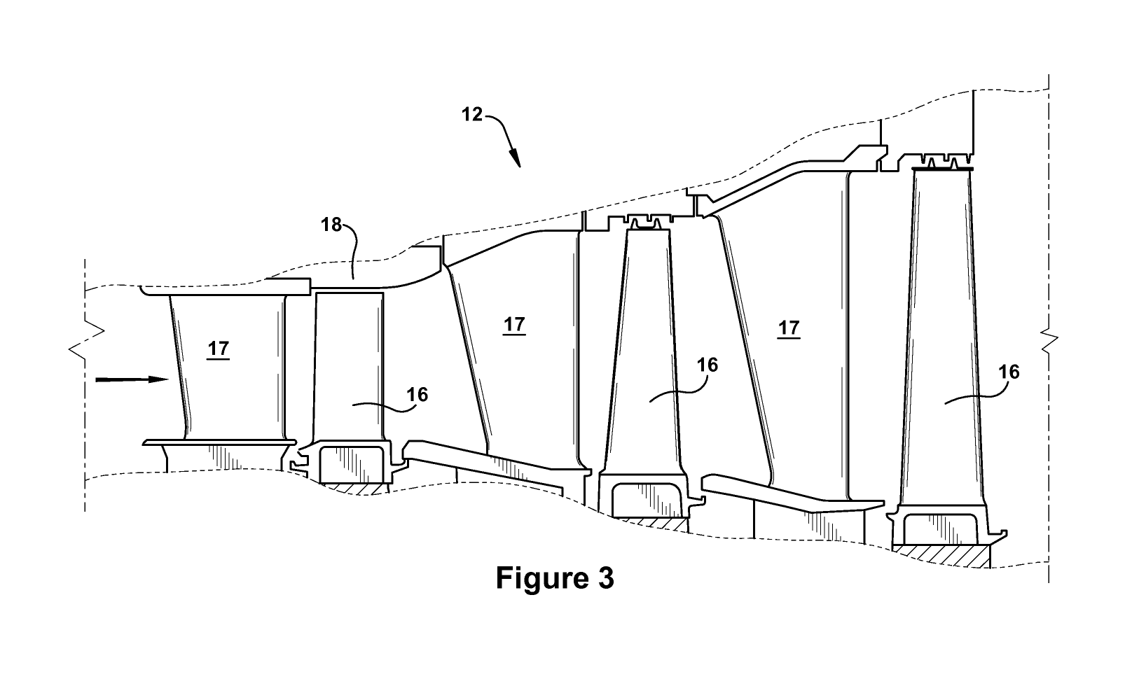

FIG. 3 illustrates a partial view of an exemplary turbine section or turbine 12 that may be used in the combustion turbine engine of FIG. 1. The turbine 12 may include a plurality of stages. Three exemplary stages are illustrated, but more or less stages may be present in the turbine 12. A first stage includes a plurality of turbine buckets or turbine rotor blades 16, which rotate about the shaft during operation, and a plurality of nozzles or turbine stator blades 17, which remain stationary during operation. The turbine stator blades 17 generally are circumferentially spaced one from the other and fixed about the axis of rotation. The turbine rotor blades 16 may be mounted on a turbine wheel (not shown) for rotation about the shaft (not shown). A second stage of the turbine 12 also is illustrated. The second stage similarly includes a plurality of circumferentially spaced turbine stator blades 17 followed by a plurality of circumferentially spaced turbine rotor blades 16, which are also mounted on a turbine wheel for rotation. A third stage also is illustrated, and similarly includes a plurality of turbine stator blades 17 and rotor blades 16. It will be appreciated that the turbine stator blades 17 and turbine rotor blades 16 lie in the hot gas path of the turbine 12. The direction of flow of the hot gases through the hot gas path is indicated by the arrow. As one of ordinary skill in the art will appreciate, the turbine 12 may have more, or in some cases less, stages than those that are illustrated in FIG. 3. Each additional stage may include a row of turbine stator blades 17 followed by a row of turbine rotor blades 16.

In one example of operation, the rotation of compressor rotor blades 14 within the axial compressor 11 may compress a flow of air. In the combustor 13, energy may be released when the compressed air is mixed with a fuel and ignited. The resulting flow of hot gases from the combustor 13, which may be referred to as the working fluid, is then directed over the turbine rotor blades 16, the flow of working fluid inducing the rotation of the turbine rotor blades 16 about the shaft. Thereby, the energy of the flow of working fluid is transformed into the mechanical energy of the rotating blades and, because of the connection between the rotor blades and the shaft, the rotating shaft. The mechanical energy of the shaft may then be used to drive the rotation of the compressor rotor blades 14, such that the necessary supply of compressed air is produced, and also, for example, a generator to produce electricity.

As will be appreciated, rotor blades in the later stages of gas turbines are elongated in order to maximize the energy extracted from the hot gas flow. As the rotor blades increase in length, the airfoil 25 is twisted about the radial axis of the blade and may include other curved surface contours for improved aero-performance, as already discussed. Another issue with larger turbine rotor blades is the effect of such a relatively large mass due to rotation of the blade under extreme high temperature. To address this, the airfoil 25 may be tapered to reduce weight. However, active internal cooling of the airfoil 25 remains a significant component in combating the extreme thermal and mechanical loads that these larger rotating blades experience. As will be appreciated, these loads lead to creep problems and/or to the blade untwisting due to deformation, which may negatively impact the aero-performance and component-life of the blade.

The aero-considerations associated with larger rotor blades and the geometrical limitations they impose, however, make the creation of certain conventional types of cooling arrangements difficult, expensive, and/or impracticable. As will be appreciated, prior art cooling of large turbine rotor blades is typically achieved by drilling radial holes into the airfoil 25 from the outboard tip or the root. However, the highly twisted and tapered profile associated with the larger rotor blades often makes long radial line-of-sight drilling impossible or cost prohibitive. Specifically, traditionally formed straight or linear radial cooling channels cannot be drilled to cover certain areas of the airfoil 25 from tip to root because of the curving and tapering profile of the airfoil 25 as it extends from the platform to the tip. Casting such cooling channels is prohibitively expensive for several reasons, including the fact that core ties used in casting the cooling channels are so easily damaged in the molds and, as a result, defectively cast. This requires highly targeted and efficient cooling solutions. Reduction of available airfoil cross sectional area for drilling radial holes is a function of the blade twist and taper. Higher airfoil twist and taper yield a lower available cross sectional area for drilling radial cooling holes. Cooling of the large, highly twisted and tapered blade by using line-of-sight drilling may not achieve the optimum blade cooling effectiveness. Especially lacking is cooling for the blade leading edge and trailing edge. This prevents the use of such blades in a high firing temperature application as well as a low cooling flow design.

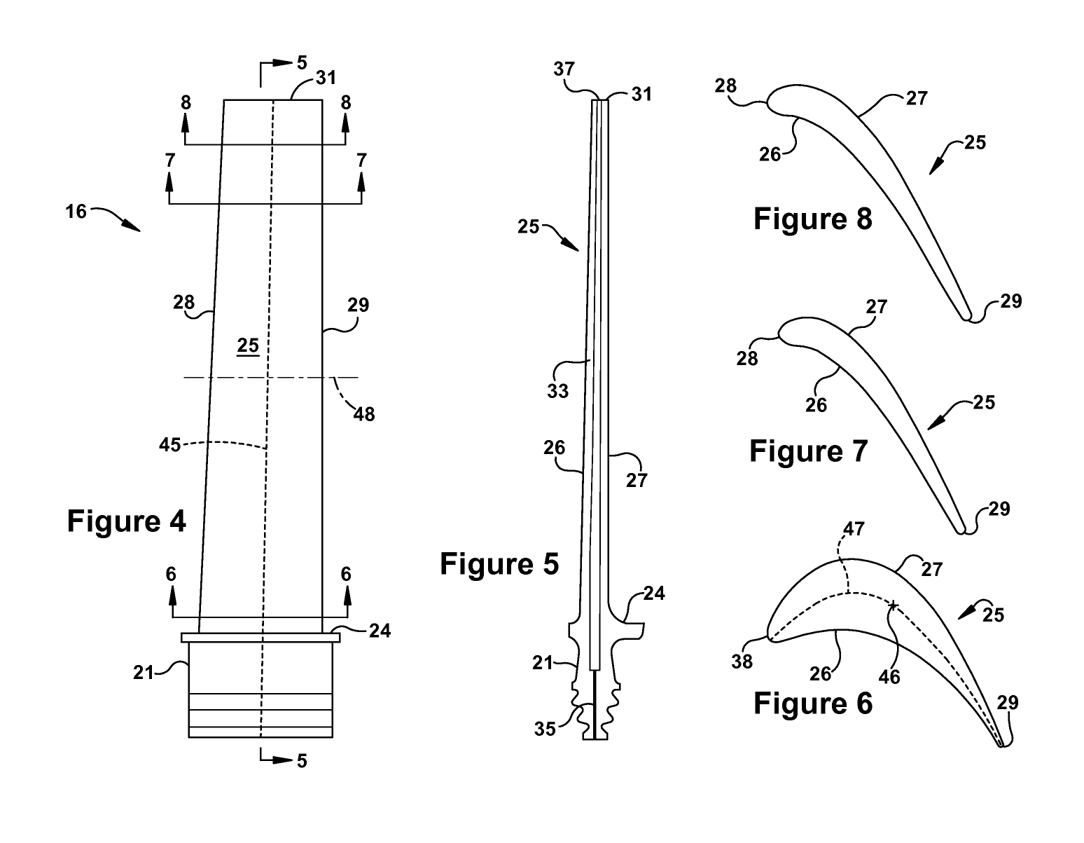

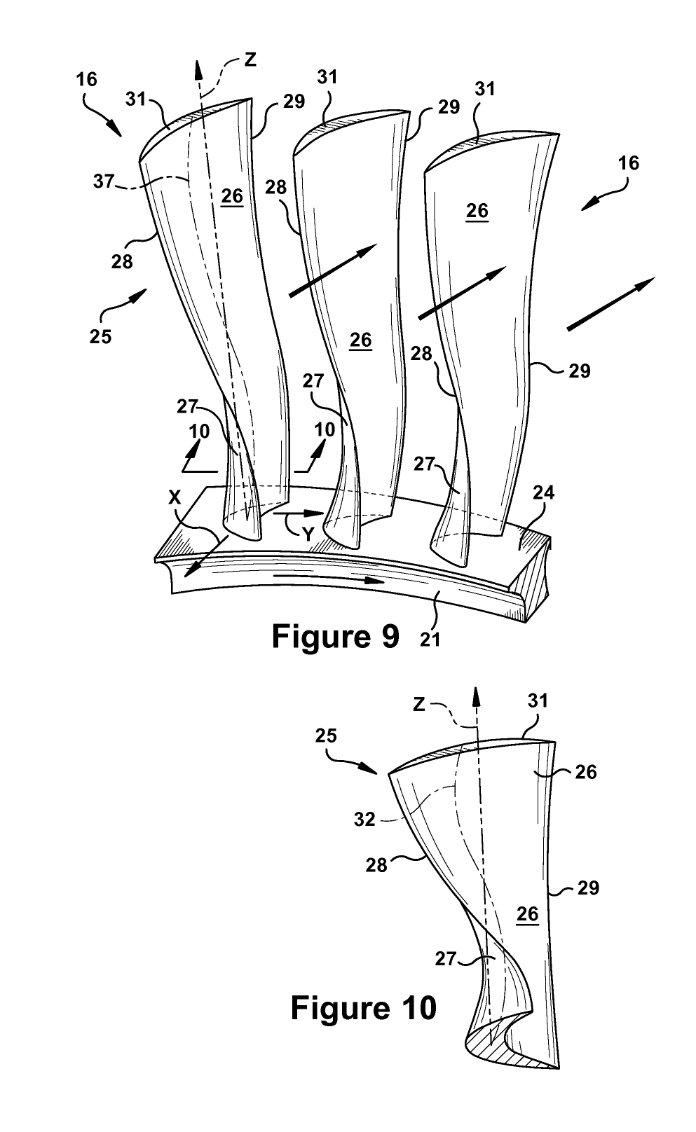

FIGS. 4 through 8 provide views of a turbine rotor blade 16 of the type described above in which embodiments of the present invention may be employed. As will be appreciated, these figures, along with FIGS. 9 and 10, are provided so to illustrate common geometrical constraints that have come to limit internal cooling configurations. As illustrated, the rotor blade 16 includes a root 21 by which the rotor blade 16 attaches to a rotor disc. The root 21 may include a dovetail configured for mounting in a corresponding dovetail slot in the perimeter of the rotor disc. The root 21 may further include a shank that extends between the dovetail and a platform 24, which is disposed at the junction of the airfoil 25 and the root 21 and defines a portion of the inboard boundary of the flow path through the turbine 12. It will be appreciated that the airfoil 25 is the active component of the rotor blade 16 that intercepts the flow of working fluid and induces the rotor disc to rotate. While the blade of this example is a rotor blade 16, it will be appreciated that, unless otherwise stated, the present invention also may be applied to other types of blades within the turbine engine 10, including stator blades 17 that may include similar configurations. It will be seen that the airfoil 25 of the rotor blade 16 includes a concave pressure side face 26 and a circumferentially or laterally opposite convex suction side face 27 extending axially between opposite leading and trailing edges 28, 29 respectively. The side faces 26 and 27 also extend in the radial direction from the platform 24 to an outboard tip 31.

The airfoil 25 may include a curved or contoured shape extending between the inboard end of the airfoil 25 (i.e., where the airfoil 25 extends radially from the platform 24) and the outboard tip 31. As will be appreciated, as the curved or contoured shape of the airfoil 25 becomes more pronounced, particular regions or areas (or as used herein “target areas 41”) within airfoils that become inaccessible to radially aligned cooling channels that extend along linear paths or reference lines. Such target areas 41 exist in the both the outboard and inboard areas of the airfoil 25 because of the geometrical limitations imposed by modern aerodynamic design. These target areas 41, as discussed more below, may also exist in prevalence toward the leading and trailing edges of the airfoil 25, particularly the trailing edge because of the more pronounced narrowing of the airfoil profile toward this end of the it. As illustrated in FIGS. 4 and 5, the airfoil 25 taper gradually as it extends from the platform 24 to the outboard tip 31, which restricts the usage of linear cooling channels 33 to this area. The tapering includes an axial tapering that narrows the distance between the leading edge 28 and the trailing edge 29 of the airfoil 25, as illustrated in FIG. 4, as well as a circumferential tapering that reduces the thickness of the airfoil 25 as defined between the suction side face 26 and the pressure side face 27. As shown in FIGS. 6 through 8, the contoured shape of the airfoil 25 may further include a twisting about a longitudinal axis of the airfoil 25 (i.e., as the airfoil extends in the radial direction relative to the turbine). The twisting typically is configured so to vary a stagger angle for the airfoil 25 gradually between the inboard end and outboard tip. However, as will be appreciated, the combined effects of the tapering and the twisting configurations adds further restriction the areas within the airfoil that are reachable using linearly formed cooling channels, such as the linear cooling channels 33 illustrated in FIG. 5, which, as shown, would have to be positioned only within the central spine of the rotor blade 16. The linear cooling passage 33, as also shown, may extend between a coolant feed 35 that extends through the root 21 of the rotor blade 16. At the other end of the linear cooling passage 33, an outlet port 37 may be formed for the release of the coolant moving through the rotor blade 16.

For descriptive purposes, as further provided in FIG. 4, the airfoil 25 may be described as including a leading half and a trailing edge half defined to each side of an axial midline 45. The axial midline 45, according to its usage herein, may be formed by connecting the midpoints 46 of the camber lines 47 of the airfoil 25 (see FIG. 6). Additionally, the airfoil 25 may be described as including two radially stacked sections defined inboard and outboard of a radial midline 48 of the airfoil 25. Thus, as used herein, the inboard section extends between the root and the radial midline 48, while the outboard section extends between the radial midline 48 and the outboard tip 31.

As illustrated in FIGS. 9 and 10, the airfoil 25 also may include a radial bowing component by which an arc or further curvature is defined along the longitudinal axis of the airfoil 25. As will be appreciated, FIGS. 9 and 10 also depict airfoil configurations that include twisting and tapering, which, when considered along with the added curvature of the bowing component, demonstrates clearly the inherent obstacles with using linear cooling channels 33 to reach all of the internal regions of the airfoil 25 that require active cooling during operation of the turbine engine.

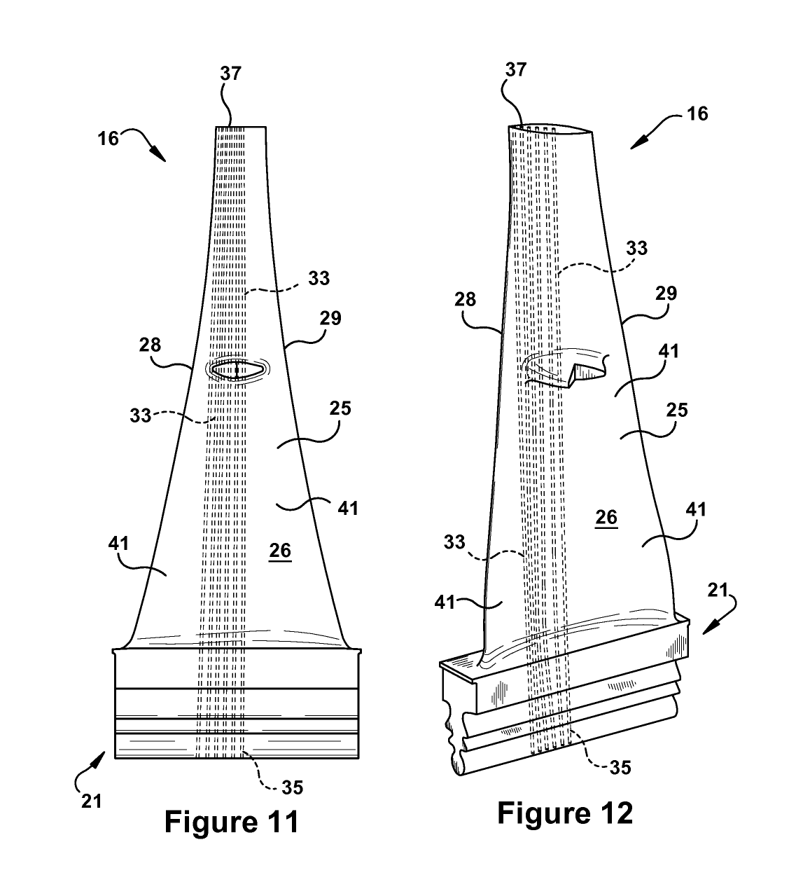

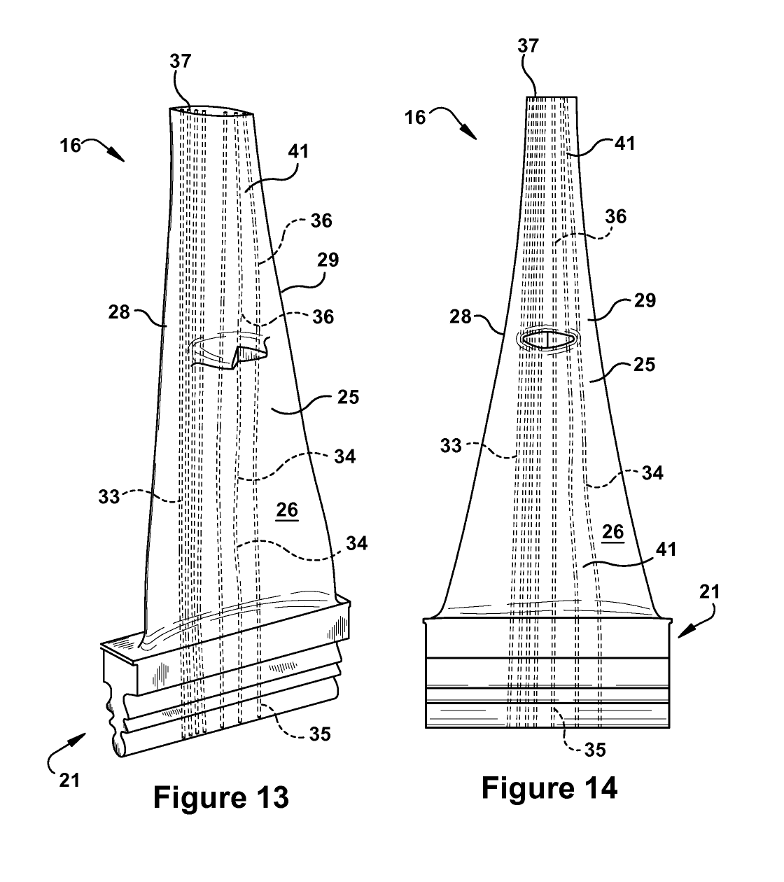

FIGS. 11 and 12, respectively, are side and perspective views of a turbine rotor blade 16 depicting conventional linear cooling channels 33, while, for the sake of comparison, FIGS. 13 and 14, respectively, provide side and perspective views of a rotor blade 16 depicting curved cooling channels 34 according to an exemplary embodiments. As illustrated in FIGS. 11 and 12, the range accessible for linear drilling within a tapered and curved airfoil 25 is limited to the central portions of the airfoil 25. As such, the target areas 41 that are inaccessible to the linear cooling channels 33 are considerable, particularly along both the leading and trailing edges. In contrast, FIGS. 13 and 14 illustrate a significantly extended area of cooling coverage enabled by the curved cooling channels 34 of the present invention. As illustrated, the curved cooling channels 34 may extend out into the highly curved and narrow areas adjacent to the trailing edge of the airfoil 25. Further, these curved cooling channels 34 may be formed so to extend under and close to the surface of either the pressure or suction side faces. More specifically, the curved configuration of the curved cooling channels 34 allows them to correspond to and follow more closely the curvature of any of the curved surface areas of the airfoil 25. This may enable a much tighter or closer placement relative to the many contoured surfaces of the airfoil 25 than would otherwise be possible with a linear configuration. As will be appreciated, enabling the placement of internal cooling circuits nearer the surface increases the cooling efficiency of the coolant.

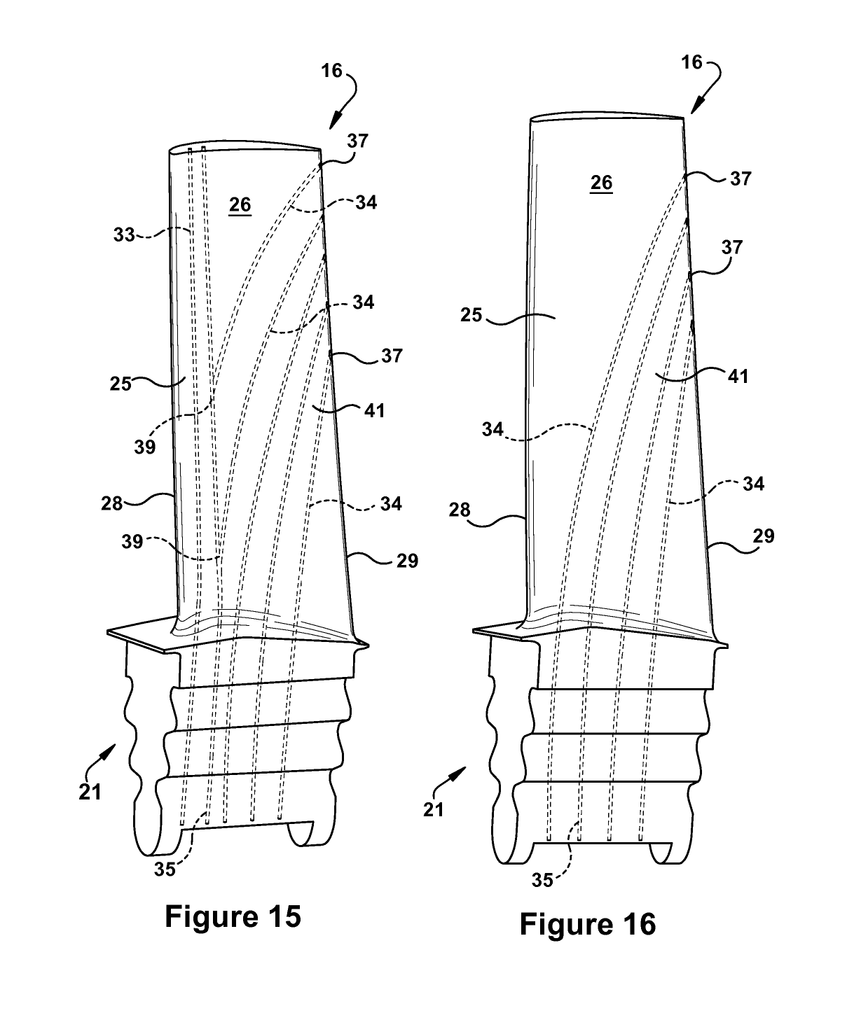

FIGS. 15, 16 and 17 are perspective views of turbine rotor blades 16 having curved cooling channels 34 according to several alternative embodiments of the present invention. As illustrated, the curved cooling channels 34 may be configured to extend between an upstream end and a downstream end so to intersect a predefined target area 41 positioned therebetween (i.e., a region inaccessible to linear cooling channels 33). According to preferred embodiments, a plurality of the curved cooling channels 34 may be provided. Alternatively, one or more curved cooling channels 34 may be used in conjunction with one or more linear cooling channels 33. As illustrated in FIG. 15, according to one embodiment, the curved cooling channels 34 may extend in parallel from an inboard position where one or more of the curved cooling channels 34 makes a mid-span connection 39 to a linear segment or linear cooling channel 33. From the mid-span connection 39, the curved cooling channels 34 may extend to an outboard position where each connects to an outlet port 37.

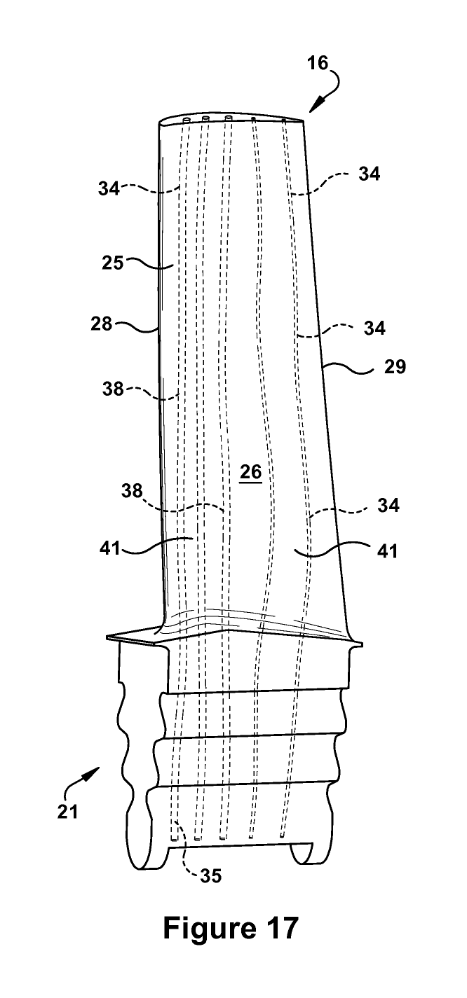

As illustrated in FIGS. 15 and 16, the curved cooling channels 34 may include an upstream end that is centrally located, i.e., positioned near the axial midline. The upstream end of the curved cooling channels 34 also may be positioned near or on the inboard end of the airfoil 25 where it may connect to a coolant feed 35. The coolant feed 35 may be configured as a hollow passage that extends through the root 21 of the rotor blade 16 so to connect to a coolant source. From the upstream end, the curved cooling channels 34 may extend in a general radial direction while including a curvature that bends according to the contoured shape of the airfoil 25. As shown, the curved cooling channels 34 may include a curvature bending toward outlet ports 37 formed along the trailing edge 29 of the airfoil 25. The outlet ports 37 may be radially spaced along the trailing edge 29 of the airfoil 25. The upstream ends of one or more of the curved cooling channels 34 may be positioned within the leading half of the airfoil 25, and the outlet ports 37 to which the curved cooling channels 34 connect may be formed through an outer surface disposed on the trailing half the airfoil 25. As will be appreciated, this type of configuration provides a long convective path for the coolant so to affect its efficient usage. As shown in FIG. 17, the outlet ports 37 may also be formed at the outboard tip of the airfoil 25. Additionally, as will be appreciated, the outlet ports 37 may be formed as needed on any exterior surface of the airfoil 25, including outlet ports formed as film cooling outlets positioned on the pressure side face 26 or the suction side face 27 of the airfoil 25. Though not shown, one or more outlet ports 37 may be configured on the leading edge 28 of the airfoil 25 so to connect curved cooling channels to this region.

According to a preferred embodiment, the curved cooling channels 34 may be configured as a post-casting feature. As used herein, a post-cast feature is a feature added to the blade after a conventional casting process forms the main body to the component. According to certain embodiments, the curved cooling channels 34 are formed using a steerable or controllable electrochemical machining process. According to other embodiments, the curved cooling channels 34 of the present invention may be formed using a controllable electric discharge machining process and/or 3D printing methods. According to certain embodiments, the rotor blade 16 in which the curved cooling channels 34 are used may be one configured for operating in an aft or downstream row of long rotor blades such as those used in multi-staged turbines.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

I claim:

1. A blade for a turbine of a gas turbine engine that includes an airfoil, the airfoil having a leading edge, a trailing edge, an outboard tip, and an inboard end where the airfoil attaches to a root configured to couple the turbine blade to a rotor disc, wherein the airfoil includes a cooling configuration that includes a plurality of elongated cooling channels for receiving and directing a coolant through the airfoil, the blade further comprising:
a contoured shape defined by the airfoil between the inboard end and the outboard tip, the contoured shape configured so to include a target area inaccessible to a linear reference line extending radially through the airfoil; and
a curved cooling channel configured to extend between an upstream end and a downstream end so to intersect the target area therebetween;
a coolant feed configured so to fluidly communicate with the downstream end of the curved cooling channel.

2. The blade according to claim 1, wherein the coolant feed extends through the root of the blade so to connect to a coolant source;
wherein the blade comprises a rotor blade and the curved cooling channel comprises a post-casting feature; and
wherein the linear reference line comprises one extending between the outboard tip and the inboard end of the airfoil.

3. The blade according to claim 2, wherein the contoured shape of the airfoil comprises at least one of:
a concave shaped pressure side face and a convex shaped suction side face that connect along the leading and trailing edges; and
a radial bowing component by which an arc is defined along a longitudinal axis of the airfoil.

4. The blade according to claim 3, wherein the contoured shape of the airfoil comprises a twisting about a longitudinal axis of the airfoil, the twisting configured so to vary a stagger angle for the airfoil gradually between the inboard end and the outboard tip.

5. The blade according to claim 4, wherein the contoured shape of the airfoil comprises a tapering along a longitudinal axis of the airfoil, the tapering comprising at least one of:
an axial tapering by which a distance between the leading edge and the trailing edge gradually decreases between the inboard end and the outboard tip of the airfoil; and
a circumferential tapering by which a thickness between the pressure side face and the suction side face gradually decreases between the inboard end and the outboard tip of the airfoil.

6. The blade according to claim 5, wherein the configuration of the linear inaccessibility of the target area comprises a combination of at least two of: the twisting about the longitudinal axis of the airfoil; the tapering along the longitudinal axis of the airfoil; and the radial bowing component by which the arc is defined along a longitudinal axis of the airfoil; and
wherein a curvature of the curved cooling channel is configured so to correspond to a curvature of the contoured shape of the airfoil.

7. The blade according to claim 6, wherein the downstream end of the curved cooling passage connects to an outlet port formed through an outer surface of the airfoil, the outlet port being positioned on at least one of: the outboard tip; the pressure side face; the suction side face; the leading edge; and the trailing edge.

8. The blade according to claim 7, wherein, at the upstream end, the curved cooling passage comprises a connection with the coolant feed, the connection comprising a position near the inboard end of the airfoil.

9. The blade according to claim 7, wherein, at the upstream end, the curved cooling passage comprises a connection with a downstream end of a linear cooling channels, the connection comprising a position within the airfoil;
wherein the linear cooling passage extends between the connection with the curved cooling passage and a connection with the coolant feed.

10. The blade according to claim 7, wherein the airfoil comprises a leading half and a trailing edge half defined to each side of an axial midline connecting midpoints of airfoil camber lines;
wherein the airfoil comprises radially stacked sections defined inboard and outboard of a radial midline of the airfoil, wherein an inboard section extends between the root and the radial midline, and an outboard section extends between the radial midline and the outboard tip; and
wherein the cooling configuration comprises a plurality of the curved cooling channels.

11. The blade according to claim 10, wherein the upstream end of each of the curved cooling channels comprises a positioned near the axial midline and inboard end of the airfoil; and
wherein the curved cooling channels comprise a curvature bending toward the outlet ports formed on at least one of: the trailing edge of the airfoil; and the leading edge of the airfoil.

12. The blade according to claim 10, wherein each of the curved cooling channels extends in parallel relative the other curved cooling channels and along a curvature bending toward the trailing edge in of the airfoil;
wherein the outlet ports comprise a radial spacing along the trailing edge of the airfoil.

13. The blade according to claim 10, wherein the upstream ends of the curved cooling channels are positioned within the leading half of the airfoil, and the outlet ports are formed through the outer surface of the trailing half the airfoil.

14. The blade according to claim 10, wherein the rotor blade is configured for operating in an aft row of rotor blades in a multi-staged turbine;
wherein the target area is positioned within the outboard section of the airfoil.

15. The blade according to claim 14, wherein the target area is positioned within the trailing half of the airfoil; and
wherein each of the curved cooling channels comprise a curvature bending toward the trailing edge of the airfoil.

16. The blade according to claim 10, wherein the cooling configuration comprises a plurality of the linear cooling channels and a plurality of curved cooling channels that each have the upstream end positioned near the inboard end of the airfoil; and
wherein each of the linear cooling channels and the curved cooling channels extend across at least a majority of a radial height of the airfoil.

17. The blade according to claim 10, wherein each of the curved cooling channels extend in parallel from an inboard position where each connects to one of the linear cooling channels at a mid-span junction to an outboard position where each connects to one of the outlet ports.

18. The blade according to claim 10, wherein one of the curved cooling channels comprises a curvature corresponding to a surface contour of the pressure side face of the airfoil; and
wherein each of the curved cooling channels comprises a curvature corresponding to a surface contour of the suction side face of the airfoil.

19. The blade according to claim 10, wherein the curved cooling channels extend radially in relation to a curvature of an area of the outer surface of the airfoil; and
wherein the curved cooling channel maintains a substantially constant offset from the area of the outer surface of the airfoil.

20. The blade according to claim 2, wherein the curved cooling channels comprise a post-cast feature formed by a machining process after the casting of the blade; and
wherein the machining process comprises one of a steerable electrochemical machining process and an electric discharge machining process.
